(19) United States
(12) Patent Application Publication
(10) Pub. No.: US 2004/0100972 A1
(43) Pub. Date: May 27, 2004

(54) Firewall with index to access rule

(76) Inventors: Anthony Peter Lumb, Nuneaton Warwickshire (GB); Keith St. Pier, Welwyn Hertfordshire (GB); Robert Anthony Weeks, Leamington Spa (GB)

Correspondence Address: Alan Israel, Kirschstein Ottinger Israel & Schiffmiller, 489 Fifth Avenue, New York, NY, 10017-6105, US

(21) Appl. No.: 10/250,958

(22) PCT Filed: Jan. 7, 2002
(86) PCT No.: PCT/GB02/00040

(30) Foreign Application Priority Data
Jan. 11, 2001 (GB) 0100713.7

(51) Int. Cl. H04L 12/26

(52) U.S. Cl. 370/401; 370/252

(57) ABSTRACT

A packet control means for checking packets according to a plurality of rules, in which each packet is associated with a control value; the packet control means comprising index means for generating an index value from the control value associated with a packet and means for using the index value to access a rule for checking the packet from the plurality of rules. The control value is set by the packet control means. Advantageously, the packet checking always requires a single access to the plurality of rules, allowing for faster operation.

The present invention relates to the field of communications in general and to packet control means in particular.

In packet based communications networks there is a need to control packet access between insecure, e.g. public networks and secure networks, such as a network internal to a business organisation, in order to prevent unauthorised access to data held on the secure network. Access control is performed by so-called firewalls. A firewall provides the interface between the secure and insecure networks and contains a packet filter for checking, under control of a firewall controller, packets routed across the interface. Checking is done by comparing characteristics of received packets against a series of rules. This allows control of IP traffic passing to and from the protected network. If a rule is found that matches a packet it is allowed to pass, subject to bandwidth constraints, otherwise the packet is rejected. Filters for firewalls may be implemented in hardware or software. The principal difference from the practical point of view is the bandwidth capability. Software filter have a lower bandwidths due to processing power limitations.

The filter provides a discretionary interface for IP packets between the unprotected side, e.g. the Internet and the protected side, e.g. a virtual private network. It is responsible for deciding which packets it will transport across the IP boundary between the protected and unprotected networks. The filter does not decide which rules are set up: this is the responsibility of elements within the system that require routes through the firewall. The filter makes the decision for each packet, by comparing data in the packet header with the rules. When a packet arrives at the filter it is dealt with in one of the following ways dependent upon the destination IP address, destination port number, protocol or other factors. It can either be rejected, in which case the packet will be discarded, or it can be accepted as a valid packet, in which case it is transported.

Packet filters for use with 1P telephony need to set up large numbers of rapidly changing rules, as determined by a call control function. (CCF) or “gatekeeper”. (A list of definitions is provided at the end of the description). This is in contrast to normal data firewalls, which use relatively few rules which are mostly static and are controlled by network management. Hence IP telephony calls need different handling from conventional data traffic as there is a need to check IP telephony packets in “real time” as delay and delay variation is critical to quality of service.

We now consider the case of an IP telephony call between two end points, the originating end point being located in an insecure network and the destination end point being located in a secure network. In IP telephony via a firewall, packets are directed to addresses/port numbers on the firewall: packets from the insecure endpoint to the insecure side of the firewall and those from the secure endpoint to the secure side.

In the prior art, the value of these IP addresses and port numbers on the firewall are determined by the endpoints of the call. Each packet received by the filter is checked against the existing rules in turn until either a rule that passes the packet is found or until all the rules have been tried without finding one that passes the packet, in which case the packet is discarded. Hashing can be used to indicate the likely location of a rule relevant to that packet. With hashing, the index value points to a location: if the location does not contain a rule, then the packet is discarded; if the location contains a rule, the packet it checked against it. Once the packet has been evaluated against the rule, a check is made in case the location contains a pointer to a second rule in a different location, against which the packet is also to be checked. This second location may also contain yet another pointer to a third rule, against which the packet is to be checked, and so on: thus the rule checking is non-deterministic. Although a single access may sometimes prove sufficient in the arrangements of the prior art, this is not guaranteed to be the case so that the bandwidth of prior art firewalls is restricted to allow for the handling of multiple access to the rule table for particular packets.

Packet checking typically involves checking the protocol being used and the source and destination IP addresses and port numbers. This is essentially the same process as used by normal data firewalls, where the rules are maintained by network management. A similar process occurs in packet routers where the rules are primarily for deciding on which exit interface to route the packet. However, all these prior art processes require a lot of processing power/time or require expensive hardware such as content addressable memory that carries out accesses to every location in parallel; and this effectively limits the maximum bandwidth for passing packets through the filter.

The present invention provides a communications system comprising a packet control means for checking packets according to a plurality of rules, in which each packet is associated with a control value; the packet control means comprising index means for generating an index value from the control value associated with a packet and means for using the index value to access a rule for checking the packet from the plurality of rules; in which the packet checking always requires a single access to the plurality of rules.

The present invention further provides a communications system comprising a packet control means for checking packets according to a plurality of rules, in which each packet is associated with a control value; the packet control means comprising index means for generating an index value from the control value associated with a packet and means for using the index value to identify a rule from the plurality of rules for checking the packet; in which the control value is set by the packet control means.

The present invention further provides a communications system comprising a packet control means for checking packets according to a plurality of rules, in which each packet is associated with a control value; the packet control means comprising index means for generating an index value from the control value associated with a packet and means for using the index value to identify a rule from the plurality of rules for checking the packet; in which the communications system also comprises packet value means, external to the packet control means, in which the control value is set by the packet value means in collaboration with the packet control means.

According to a preferred embodiment, the invention provides a communications system in which the packet control means comprises means for determining whether the packet control means should pass or reject the packet.

The present invention further provides a method of filtering packets in a packet-based communications system comprising a packet control means; the method including the steps of receiving a packet comprising a control value at the control means and the step of using the control value to access a rule from a plurality of rules for use in checking the packet; in which the packet checking always requires a single access to the plurality of rules.

The present invention further provides a method of filtering packets in a packet-based communications system comprising a packet control means; the method including the steps of receiving a packet comprising a control value at the control means, the step of using the control value to identify a rule for use in checking the packet from a plurality of rules in which the packet control means allocates the control value to the packet.

The present invention further provides a method of filtering packets in a packet-based communications system comprising a packet control means and packet value means; the method including the steps of receiving a packet comprising a control value at the control means, the step of using the control value to identify a rule for use in checking the packet from a plurality of rules in which the packet value means allocates the control value in collaboration with the packet control means.

According to a further preferred embodiment, method includes the step of determining whether the packet control means should pass or reject the packet.

Embodiments of the invention will now be described by way of example, with reference to the drawings in which:

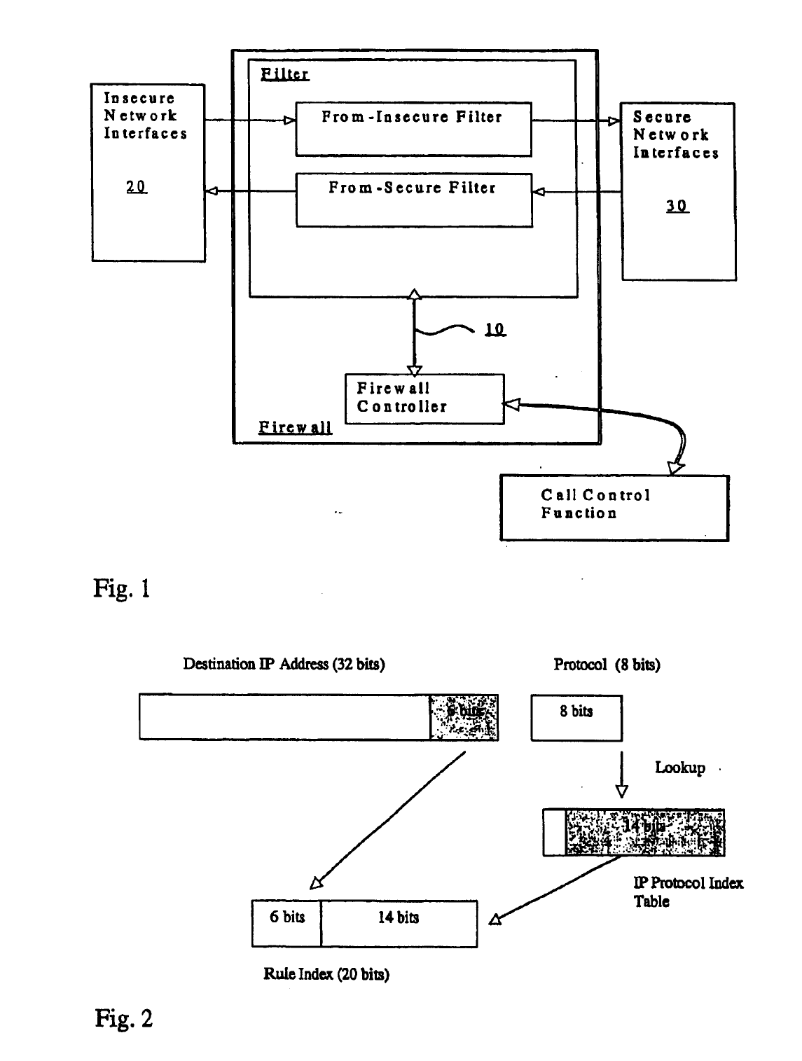

FIG. 1 shows a block diagram of the main components of a conventional firewall filter;

FIGS. 2 to 4 show various ways for calculation of the Rule Index according to the present invention.

The following embodiments are described in relation to IP version 4, however the invention also applies to systems using IP version 6.

Referring to FIG. 1, to set up an IP telephony call, the originating endpoint will send a registration packet bearing the IP address and port number of the firewall. The filter directs the registration packet to the firewall controller which forwards the registration packet to the appropriate call control function (known as a gatekeeper in H.323) for checking. The registration packet contains the IP address and port number of the originating end point. If the registration packet passes the checks performed by the CCF, the CCF sends a reply packet to the originating endpoint via the filter. In doing so, the firewall controller typically sets up two rules in the filter for that call (one for each direction). These rules will normally form part of a large table held in the firewall containing other rules for dealing with large numbers of concurrent calls. The IP address and port number on the insecure side of the filter (i.e. the originating side) is communicated to the originating end point. This IP address and port number will then be used by the originating end point as the destination address of future packets as part of that call. Similarly, the IP address and port number on the protected side of the filter (i.e. on the CCF side) is communicated to the CCF. The CCF then uses this IP address and port number as the destination address for packets sent to the originating end point as part of that call. This process is applicable to a range of telephony protocols including H.323, MGCP, SIP and H.248. These firewall addresses and port numbers are conventionally assigned by the end points.

The firewall comprises a filter that processes the IP packets that come from the interfaces with the secure (30) and insecure (20) networks. In order to perform this processing the filter uses data that has been set-up by the firewall controller across the control interface (10) with the filter. In particular, the source IP address, port number, the destination address and port number, and the IP protocol are set by the firewall controller.

There are 64 thousand ports number available including 16384 user defined ports and 49152 ports assigned by IANA (referred to below as “well known ports”).

The first check on an incoming packet is for packets using the ARP protocol as these are handled differently to the rest. ARP (Address Resolution Protocol) packets are dealt with locally on the network interface. If the incoming packet is not an ARP then the following tests are carried out.

A check is performed to ensure that the IP version of the packet is the same as that currently operated by the filter. Each filter can only operate one IP version and it must be the same for both filter directions. Checks are performed on the length of the IP header and the protocol. A check is performed by the filter on the IP header length field to ensure that the length of the packet header is at or above a predefined minimum, e.g. 20 octets. The filter also performs a check to establish if the IP protocol field of the packet header corresponds to a valid entry in the acceptable protocol table.

If these checks are passed then an index to the rule table is generated and used to establish if there is a rule present at that location. If any of the above checks fail, or if the location does not contain a rule, some statistics about the packet are logged and the packet is discarded.

A check is performed to establish if the packet has a multicast IP address. If it has then a rule index is extracted from a multicast 1P address table. The Multicast IP address table provides a 20 bit index to be used to route multicast packets through the filter akin to the arrangements shown in FIGS. 2 & 3 (see below). Multicast packets will normally be routed to the firewall controller. Some statistics are logged about the packet and it is passed for transmission to its destination.

Flags within a rule determine which items of data are changed within the packet header and which items of statistical information are updated by the filter. The destination IP address within the packet header may be changed to a modified destination address stored in the rule. The destination port number within the packet header may be changed to a modified destination port number stored in the rule. The source address may be changed to a modified source address stored in the rule. The source port number within the protocol header may be changed to a modified source port number stored in the rule.

The above changes to the header are required to ensure that packets are directed correctly from a first endpoint to the filter and then from the filter to a second endpoint, and vice versa on the return journey. The differentiated services (or “diffserv”) bits from the rule, i.e. the set of bits in the packet header that allow routers to differentiate between different classes of packets e.g., different priorities, may be added to the packet header in the appropriate place. The packet header checksums are recalculated after any data changes have taken place.

FIGS. 2 to 4 show how the rule index is calculated for different types of incoming packets. In the figures the least significant bit (bit 0) is at the right hand side of each field.

According to a preferred embodiment of the present invention, the allocation of IP addresses and port numbers to the firewall filter is performed by a firewall control function that is arranged to generate unique locations in such a way as to allow for rapid identification of the appropriate rule for subsequent packets forming part of the same call. According to a further preferred embodiment of the present invention, the allocation of IP addresses and port numbers to the firewall filter is performed by a platform external to the firewall that is arranged to generate unique locations in collaboration with the firewall control function in such a way as to allow for rapid identification of the appropriate rule for subsequent packets forming part of the same call. Rather than using a process of checking each rule in turn, the invention advantageously provides for using a field from received packets whose content is set locally to the firewall (as described above), as opposed to being set by endpoints to provide an index directly to the relevant rule (or to the relevant location in the table of rules). Hence, if an appropriate rule has been set up the index value will point directly to it. If the index value does not indicate a valid rule, then the packet concerned is rejected. Even in rejecting packets, the invention provides increased efficiency. Hence, according to the present invention, the decision to pass or reject a packet is always achieved with a single access to the rule table.

FIG. 2 shows calculation of the rule index for non-TCP/UDP protocols. For protocols other than TCP or UDP the rule index is calculated based on a value in a “IP Protocol Index Table” indicated by the 8-bit protocol ID value along with the IP address. The IP protocol index table is provided on the firewall. The value specified in the protocol field is used as an index into the protocol table. The indicated entry is the table indicates whether the protocol is valid or not. If the protocol is valid, then the rule index is formed by taking the least significant 6 bits from the IP address along with the least significant 14 bits taken from the indicated entry in the IP Protocol Index Table that relates to that protocol.

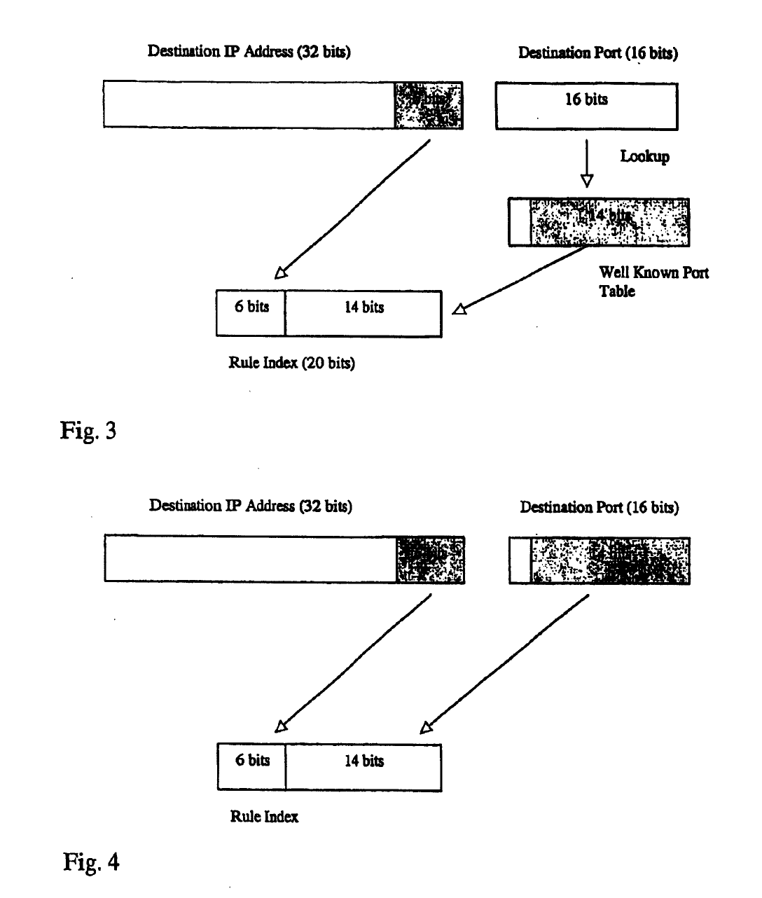

FIG. 3 shows calculation of the rule index for “well known ports”. If the protocol is TCP or UDP and the port number is in the range 0000-BFFF hexadecimal the port number is used as an index to the “well known port” table. The “well known port” table contains port numbers with specific identities as defined by IANA (e.g. 79=finger). This table is used to establish if the port is supported on this filter. Assuming that the port is supported, an index to the rule data is based on a value from the table indicated by the destination port number along with the IP address. The rule index is formed by taking the least significant 6 bits from the IP address along with the least significant 14 bits taken from the entry in the Well Known Port number table indicated by that port number. If a port is not supported, then packets sent to it are discarded.

FIG. 4 shows calculation of the rule index for User Ports. For TCP and UDP protocols where it is not a Well Known Port (i.e. the port number is in the range C000-FFFF hexadecimal) the rule index is formed from part of the port number and the IP address. The rule index is formed by taking the least significant 6 bits from the IP address along with the least significant 14 bits of the port number.

The exception to the above is for any IPSEC packets. There are two versions of IPSEC protocol types, IP protocol 50 ESP (Encapsulating Security Payload) and IP protocol 51 AH (Authentication Header). Both these versions include a Security Parameters Index (SPI). For ESP this field is in the first 32 bits and for AH in the second 32 bits of the Security Header. The SPI, along with the destination IP address and protocol uniquely identify the packet. Formatting the rule index for these packets is achieved by a similar process to that described above for user ports but using the lowest fourteen bits of the SPI and the lowest 6 bits of the IP address rather than the destination port number. Note that after the rule index is formulated the filter carries out check and replace functions according to the values in the control field of the rule data. For the IPSEC packet the principle difference is that there is just the one value, the SPI, rather than the source and destination port numbers, though this value is stored in the same location. This value will still be checked and replaced if required, as directed by the rule.

The rule index is used to access the rule and the checks stipulated by the rule control and validity word (a part of the rule that determines criteria used in checking the packet) are performed. If these checks are passed, the packet header addresses and ports etc., are translated as required.

The IP header checksums are recalculated and the UDP/TCP header checksums are adjusted, if required, i.e. due to IP addresses from the IP header that are changed. The valid packet statistical information is updated to include the present packet. If any of the checks fail then some statistics about the packet are logged and the packet is discarded.

Packets may be discarded for any one of the following reasons.

The IP version within the packet does not match that of the filter e.g. IPv4 when the filter is running IPv6 or vice versa

Incorrect destination IP address: each filter has a range of IP addresses that it acts for, including multicast addresses and private IP addresses. Any packet with an IP address that is not in the filter's range will be rejected.

The header length of the packet is less than the minimum size needed to verify the packet as correct.

The protocol is one not accepted by the filter. The filter supports a number of protocols that are acceptable and if the protocol field of the packet header is not in this list the packet is rejected.

The rule index calculated from the IP address and port number (or SPI for IPSEC) references a rule that is not in an open state that will allow transfer of packets

The sender's IP address in the packet header does not match the original source IP address field in the rule data.

The protocol field from the packet header does not match the original protocol ID field of the rule data.

The source port number from the packet header does not match the original source port number in the rule data.

The destination port in the packet header does not match the original destination port number from the rule data (for non IPSEC packets)

The destination SPI in the packet header does not match the original destination SPI from the rule data (for IPSEC packets—see below).

The destination port number is less than ‘C000’ hexadecimal (which therefore is for a “well known port”) but no entry in the “well known port” table exists.

The destination IP address field of the packet header does not match the original destination 1P address field of the rule data.

The rule index calculated from the IP address and port number (or SPI for IPSEC) references a rule that is not set up.

The present invention applies to packet filters whether implemented in hardware or software. The present invention is not limited to IP over Ethernet, but applies to other network types such as packet over SONET/SDH, and ATM AAL5. The present invention achieves optimum performance whilst using cheap random access memory.

Definitions

| | |
|---|---|
| Address Resolution | A protocol for mapping an IP address to a |
| Protocol (ARP) | physical machine address that is recognised in |
| | the local network. |
| Gatekeeper | An entity in an IP Telephony network. It |
| | performs a) RAS of other entities in the |
| | network, b) address translation for parties |
| | making calls and c) control of Gateways. |
| H.225 | ITU-T standard defining call signalling |
| | protocols and media stream packetization for |
| | packet-based multimedia communications |
| | systems. |
| H.323 | ITU-T standard for packet-based multimedia |
| | communications systems. |
| IANA | IANA. |
| ITU-T | International Telecommunications Union- |
| | Telecommunications |
| IETF | Internet Engineering Task Force. |
| Internet Protocol (IP) | The network layer protocol for IP networks, |
| | providing unreliable point-to-point transfer of |
| | data packets (datagrams). The currently used |
| | standard is version 4 (IPv4) defined in IETF |
| | RFC 791. This will be replaced in the future |
| | by version 6 (IPv6) defined in IETF RFC |
| | 2460. |
| IP Telephony, | The technology of telephony over IP |
| Voice over Internet, | protocol based networks. |
| Multimedia over IP | |
| Media Gateway Control | A proposed protocol of the ITU-T |
| Protocol (MGCP) | MEGACO working group, for control of |
| | Media Gateways by Gatekeepers. Defined |
| | in Internet Draft document draft-huitema- |
| | megaco-mgcp-v0r1-05. |
| MEGACO | MEGACO defines the protocols used |
| | between elements of a physically |
| | decomposed multimedia gateway. The |
| | MEGACO framework is described in IETF |
| | Internet Draft document draft-ietf-megaco- |
| | protocol-04. |
| Registration, Admission | Signalling function within the H.323 |
| and Status (RAS) | protocol providing registration for entities in |
| | a network, authentication of users making IP |
| | Telephony calls, and status information on |
| | registrations. RAS uses H.225 messages. |
| | The RAS signalling channel is opened prior |
| | to the establishment of any other channels |
| | between H.323 endpoints. |
| Transmission Control | A connection-oriented, reliable transport- |
| Protocol (TCP) | layer protocol designed to operate over the |
| | IP protocol. Defined by IETF RFC 793. |
| User Datagram Protocol | A connectionless, unreliable transport layer |
| (UDP) | protocol designed to operate over the IP |
| | protocol. Defined in IETF RFC 768. |

1. A communications system comprising a packet control means for checking packets according to a plurality of rules, in which each packet is associated with a control value;
the packet control means comprising index means for generating an index value from the control value associated with a packet and means for using the index value to access a rule for checking the packet from the plurality of rules;
in which the packet checking always requires a single access to the plurality of rules.

2. A communications system comprising a packet control means for checking packets according to a plurality of rules, in which each packet is associated with a control value; the packet control means comprising index means for generating an index value from the control value associated with a packet and means for using the index value to identify a rule from the plurality of rules for checking the packet; in which the control value is set by the packet control means.

3. A communications system comprising a packet control means for checking packets according to a plurality of rules, in which each packet is associated with a control value;
the packet control means comprising index means for generating an index value from the control value associated with a packet and means for using the index value to identify a rule from the plurality of rules for checking the packet;
in which the communications system also comprises packet value means, external to the packet control means, in which the control value is set by the packet value means in collaboration with the packet control means.

4. The communications system as claimed in any above claim in which the packet control means comprises means for determining whether the packet control means should pass or reject the packet.

5. The communications system as claimed in any above claim in which the control value comprises an address and/or a port number (PN).

6. The communications system as claimed in claim 5 in which the index means comprises a means for using the PN value as a pointer into a look-up table; in which the index means also comprises a means for generating the index value from the combination of the address and the look-up table value indicated by the PN.

7. The communications system of any one of claims 1 to 4 in which the control value comprises an address and a protocol value.

8. The communications system of claim 7 in which the index means comprises a means for using the protocol value as a pointer into a look-up table; in which the index means also comprises means for generating the index value based on the address and the look-up table value indicated by the protocol value.

9. The communications system as claimed in any above claim in which the index means comprises means for detecting multi-cast packets and for identifying a single rule for such packets.

10. The communications system as claimed in any above claim in which the control value is unique at any point in time for packets received from a particular source and relating to a particular call.

11. The communications system as claimed in any above claim in which the address is an internet protocol address.

12. The communications system as claimed in any above claim in which the PN is a User Datagram Protocol (UDP), Transmission Control Protocol (TCP), or Stream Control Transmission Protocol (SCTP) PN.

13. The communications system as claimed in any above claim in which the packet control means comprises a firewall.

14. The communications system as claimed in any above claim in which the packets carry telephony traffic.

15. A method of filtering packets in a packet-based communications system comprising a packet control means; the method including the steps of receiving a packet comprising a control value at the control means and the step of using the control value to access a rule from a plurality of rules for use in checking the packet; in which the packet checking always requires a single access to the plurality of rules.

16. A method of filtering packets in a packet-based communications system comprising a packet control means; the method including the steps of receiving a packet comprising a control value at the control means, the step of using the control value to identify a rule for use in checking the packet from a plurality of rules in which the packet control means allocates the control value to the packet.

17. A method of filtering packets in a packet-based communications system comprising a packet control means and packet value means; the method including the steps of receiving a packet comprising a control value at the control means, the step of using the control value to identify a rule for use in checking the packet from a plurality of rules in which the packet value means allocates the control value in collaboration with the packet control means.

18. The method of claim 15 to 17 including the step of determining whether the packet control means should pass or reject the packet.

19. The method of any one of claims 15 to 18 in which the control value comprises a PN and/or an address.

20. The method of claim 19 in which the index means uses the PN value as a pointer into a look-up table; in which the index means also generates the index value from the combination of the address and the look-up table value indicated by the PN.

21. The method of any one of claims 15 to 18 in which the control value comprises an address and a protocol value.

22. The method of claim 21 in which the index means uses the protocol value as a pointer into a look-up table; in which the index means generates the index value based on the address and the look-up table value indicated by the protocol value.

23. The method as claimed in any one of claims 15 to 22 in which the index means comprises means for detecting multi-cast packets and for identifying a single rule for such packets.

24. The method as claimed in any one of claims 15 to 23 in which the control value is unique at any point in time for packets received from a particular source and relating to a particular call.

25. The method as claimed in any one of claims 15 to 24 in which the address is an internet protocol address.

26. The method as claimed in any one of claims 15 to 25 in which the PN is a UDP, TCP or SCTP PN.

27. The method as claimed in any one of claims 15 to 26 in which the packet control means comprises a firewall.

28. The method as claimed in any one of claims 15 to 27 in which the packets carry telephony traffic.

29. The method as claimed in any one of claims 15 to 28 including the step of using the address and PN as an index into a table of rules for identifying the appropriate rule.
